(19) United States
(12) Patent Application Publication
(10) Pub. No.: US 2016/0290599 A1
(43) Pub. Date: Oct. 6, 2016

(54) LUMINAIRE WITH SEMI-SPECULAR REFLECTOR

(71) Applicant: 3M INNOVATIVE PROPERTIES COMPANY, St. Paul, MN (US)

(72) Inventor: Guy M. Kallman, Woodbury, MN (US)

(21) Appl. No.: 15/036,946

(22) PCT Filed: Dec. 16, 2014
(86) PCT No.: PCT/US2014/070505

§ 371 Date: May 16, 2016

Related U.S. Application Data
(60) Provisional application No. 61/920,024, filed on Dec. 23, 2013.

(51) Int. Cl. F21V 7/22

(52) U.S. Cl. CPC F21V 7/22; F21Y 2101/02

(57) ABSTRACT

A luminaire is provided which includes an LED light source and a reflector that includes a semi-specular reflective film. The semi-specular reflective film has a transport ratio (TR) of between 40% and 70% and a reflectivity of greater than 95% and comprises a multilayer optical film (MOF), a an ultra-low index (ULI) layer having a refractive index of less than 1.3, and a diffusing layer (DL) borne on the reflecting face of the semi-specular reflective film. The LED light source and reflector are in fixed arrangement such that the luminaire may be arranged relative to an architectural surface such that 75% or more of visible light emerging from the LED light source strikes the reflector and subsequently strikes the architectural surface without reflection off of any other surface nor transmission through any medium other than ambient air.

### FIELD OF THE DISCLOSURE

This disclosure relates to a luminaire that includes an LED light source and a reflector that includes a semi-specular reflective film.

### BACKGROUND OF THE DISCLOSURE

The following references may be relevant to the present disclosure and are incorporated herein by reference: WO2012054318 (US20130215512), WO2011050233 (US2012206674), WO2012054680 (US2013202867), WO2012054319 (US2013208360), US20100238686 and US20080037127.

Current reflector technology for lighting includes polished metal, silver coated aluminum, paints, white plastic, MCPET, aluminum coated plastic, silver coated plastic, and brushed and textured metals; however these current options each have shortcomings. For example, white paint can provide a wide range of finishes, however it is relatively low in total reflectivity. Silver coated aluminum can be purchased both in a specular or textured form at high reflectivity, however, semi-specular patterns result in glare points or “Sparkle”. MCPET is a high total reflectivity material, but it is typically fully lambertian though some variants also have the added complication of a high gloss surface resulting in poor hiding of point sources of light such as LED's.

### SUMMARY OF THE DISCLOSURE

Briefly, the present disclosure provides a luminaire comprising: a) an LED light source; and b) a reflector having a reflective surface bearing a semi-specular reflective film having a transport ratio (TR) of between 40% and 70% and a reflectivity of greater than 95%; where the semi-specular reflective film has a reflecting face and a back face and comprises a multilayer optical film (MOF), a an ultra-low index (ULI) layer having a refractive index of less than 1.3, and a diffusing layer (DL) borne on the reflecting face of the semi-specular reflective film; and where the LED light source and reflector are in fixed arrangement such that the luminaire may be arranged relative to an architectural surface such that 75% or more of visible light emerging from the LED light source strikes the reflector and subsequently strikes the architectural surface without reflection off of any other surface nor transmission through any medium other than ambient air. In some embodiments, the semi-specular reflective film has a reflectivity of greater than 96%, in some greater than 97%, and in some greater than 98%. In some embodiments, the semi-specular reflective film has a transport ratio (TR) of between 43% and 67%, in some between 43% and 55%, and in some between 55% and 67%. In some embodiments, the ULI layer is borne on the back face of the semi-specular reflective film. In some embodiments, the ULI layer is borne on the reflecting face of the semi-specular reflective film. In some embodiments, the semi-specular reflective film comprises on its back face the ULI layer, the ULI layer being in direct contact with the MOF, and comprises on its reflecting face the DL, the DL being in direct contact with the MOF. In some embodiments, the semi-specular reflective film comprises on its reflecting face the ULI layer, the ULI layer being in direct contact with the MOF, and the DL, the DL being in direct contact with the ULI layer. In some embodiments, the LED light source and reflector are in fixed arrangement such that the luminaire may be arranged relative to an architectural surface such that 80% or more of visible light emerging from the LED light source strikes the reflector and subsequently strikes the architectural surface without reflection off of any other surface nor transmission through any medium other than ambient air; in some 85% or more; in some 90% or more; and in some 95% or more.

### BRIEF DESCRIPTION OF THE DRAWING

FIG. 1 is a cross-sectional view of a semi-specular reflective film according to the present disclosure.

### DETAILED DESCRIPTION

Briefly, the present disclosure provides a luminaire comprising: an LED light source; and a reflector having a reflective surface bearing a semi-specular reflective film having a transport ratio (TR) of between 40% and 70% and a reflectivity of greater than 95%, in some embodiments greater than 96%, in some embodiments greater than 97%, and in some embodiments greater than 98%. In some embodiments the semi-specular reflective film has a transport ratio (TR) of between 43% and 67%, in some embodiments between 43% and 55%, and in some embodiments between 55% and 67%.

As used herein, transport ratio (TR) describes how much light moves forward when light is incident at a specified angle. A TR of 1 (100%) means all light moves forward (no backscatter). Specular films have TR of 1 (100%). A TR of 0 is totally Lambertian, that is, an equal amount of light moves forward to that which is back scattered.

Typically, the semi-specular reflective film has a reflecting face and a back face and comprises a multilayer optical film (MOF), a an ultra-low index (ULI) layer having a refractive index of less than 1.3, and a diffusing layer (DL) borne on the reflecting face of the semi-specular reflective film. Suitable films, including suitable MOF, ULI and DL components, include those disclosed in WO2012054318 (US20130215512), WO2011050233 (US2012206674), WO2012054680 (US2013202867), WO2012054319 (US2013208360), US20100238686 and US20080037127, the content of which is incorporated herein by reference. In some embodiments, the DL comprises polyvinyl butyral. In some embodiments, the DL comprises a mixture of polyvinyl butyral and polyvinyl alcohol. In some embodiments, the DL additionally comprises polystyrene beads. In some embodiments, the ULI layer is borne on the back face of the semi-specular reflective film. In some embodiments, the ULI layer is borne on the reflecting face of the semi-specular reflective film. In some embodiments, the semi-specular reflective film comprises on its back face the ULI layer, the ULI layer being in direct contact with the MOF, and comprises on its reflecting face the DL, the DL being in direct contact with the MOF. Thus the resulting film comprises: ULI layer, MOF, and DL, in that order and in direct contact one with the next. In some embodiments, the semi-specular reflective film comprises on its reflecting face the ULI layer, the ULI layer being in direct contact with the MOF, and the DL, the DL being in direct contact with the ULI layer. Thus the resulting film comprises: MOF, ULI layer, and DL, in that order and in direct contact one with the next.

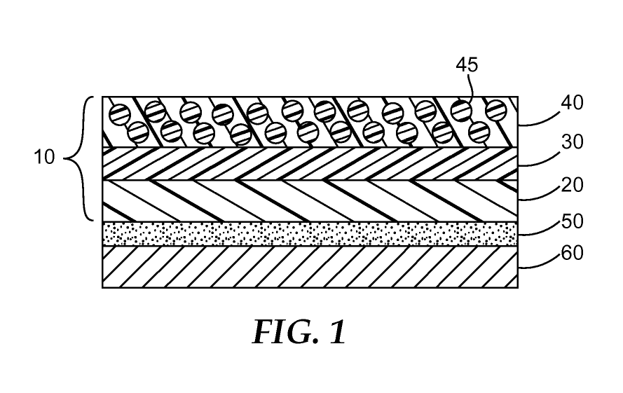

With reference to FIG. 1, in one embodiment a semi-specular reflective film 10 and comprises (in order from the back face to the reflecting face of the semi-specular reflective film): a multilayer optical film (MOF) 20, a an ultra-low index (ULI) layer 30, and a diffusing layer (DL) 40 such as a polyvinyl butyral (PVB) coating. In some embodiments, the DL additionally comprises polystyrene (PS) beads 45. Semi-specular reflective film 10 is bound to metal support 60 by adhesive 50.

The LED light source and reflector are in fixed arrangement such that the luminaire may be arranged relative to an architectural surface such that 75% or more of visible light emerging from the LED light source strikes the reflector and subsequently strikes the architectural surface without reflection off of any other surface nor transmission through any medium other than ambient air. In some embodiments, 80% or more of visible light emerging from the LED light source strikes the reflector and subsequently strikes the architectural surface without reflection off of any other surface nor transmission through any medium other than ambient air, in some 85% or more, in some 90% or more, and in some 95% or more. In some embodiments the reflector may comprises the semi-specular reflective film alone. In some embodiments the reflector may comprises the semi-specular reflective film borne on a support. Any suitable support may be used, including metal supports such as aluminum or polymeric supports. Architectural surfaces may include interior or exterior surfaces, which may include walls, floors, ceilings, domes, columns, arches, and the like; as well as articles supported on such surfaces. In various embodiments the luminaire may be fixed to the architectural surface, may be fixed to a different nearby architectural surface, may be fixed to a nearby support, or may be movable.

In some embodiments, the luminaire according to the present disclosure simultaneously satisfies multiple conflicting goals, obtaining efficiency (high reflectivity), yet eliminating unpleasant hot spots (which are in particular a problem with the use of LED's), yet retaining directionality and the ability to steer a light beam for aesthetic purposes.

Various modifications and alterations of this disclosure will become apparent to those skilled in the art without departing from the scope and principles of this disclosure, and it should be understood that this disclosure is not to be unduly limited to the illustrative embodiments set forth hereinabove.

1. A luminaire comprising:
a) an LED light source; and
b) a reflector having a reflective surface bearing a semi-specular reflective film having a transport ratio (TR) of between 40% and 70% and a reflectivity of greater than 95%;
wherein the semi-specular reflective film has a reflecting face and a back face and comprises a multilayer optical film (MOF), a an ultra-low index (ULI) layer having a refractive index of less than 1.3, and a diffusing layer (DL) borne on the reflecting face of the semi-specular reflective film,
wherein the LED light source and reflector are in fixed arrangement such that the luminaire may be arranged relative to an architectural surface such that 75% or more of visible light emerging from the LED light source strikes the reflector and subsequently strikes the architectural surface without reflection off of any other surface nor transmission through any medium other than ambient air.

2. The luminaire according to claim 1 wherein the semi-specular reflective film has a reflectivity of greater than 96%.

3. The luminaire according to claim 1 wherein the semi-specular reflective film has a reflectivity of greater than 97%.

4. The luminaire according to claim 1 wherein the semi-specular reflective film has a reflectivity of greater than 98%.

5. The luminaire according to claim 1 wherein the semi-specular reflective film has a transport ratio (TR) of between 43% and 67%.

6. The luminaire according to claim 1 wherein the semi-specular reflective film has a transport ratio (TR) of between 43% and 55%.

7. The luminaire according to claim 1 wherein the semi-specular reflective film has a transport ratio (TR) of between 55% and 67%.

8. The luminaire according to claim 1 wherein the ULI layer is borne on the back face of the semi-specular reflective film.

9. The luminaire according to claim 1 wherein the ULI layer is borne on the reflecting face of the semi-specular reflective film.

10. The luminaire according to claim 1 wherein the semi-specular reflective film comprises on its back face the ULI layer, the ULI layer being in direct contact with the MOF, and comprises on its reflecting face the DL, the DL being in direct contact with the MOF.

11. The luminaire according to claim 1 wherein the semi-specular reflective film comprises on its reflecting face the ULI layer, the ULI layer being in direct contact with the MOF, and the DL, the DL being in direct contact with the ULI layer.

12. The luminaire according to claim 1 wherein the LED light source and reflector are in fixed arrangement such that the luminaire may be arranged relative to an architectural surface such that 80% or more of visible light emerging from the LED light source strikes the reflector and subsequently strikes the architectural surface without reflection off of any other surface nor transmission through any medium other than ambient air.

13. The luminaire according to claim 1 wherein the LED light source and reflector are in fixed arrangement such that the luminaire may be arranged relative to an architectural surface such that 85% or more of visible light emerging from the LED light source strikes the reflector and subsequently strikes the architectural surface without reflection off of any other surface nor transmission through any medium other than ambient air.

14. The luminaire according to claim 1 wherein the LED light source and reflector are in fixed arrangement such that the luminaire may be arranged relative to an architectural surface such that 90% or more of visible light emerging from the LED light source strikes the reflector and subsequently strikes the architectural surface without reflection off of any other surface nor transmission through any medium other than ambient air.

15. The luminaire according to claim 1 wherein the LED light source and reflector are in fixed arrangement such that the luminaire may be arranged relative to an architectural surface such that 95% or more of visible light emerging from the LED light source strikes the reflector and subsequently strikes the architectural surface without reflection off of any other surface nor transmission through any medium other than ambient air.

16. The luminaire according to claim 1 wherein the semi-specular reflective film has a reflectivity of greater than 98% and the semi-specular reflective film has a transport ratio (TR) of between 43% and 67%.

17. The luminaire according to claim 10 wherein the semi-specular reflective film has a reflectivity of greater than 98% and the semi-specular reflective film has a transport ratio (TR) of between 43% and 67%.

18. The luminaire according to claim 11 wherein the semi-specular reflective film has a reflectivity of greater than 98% and the semi-specular reflective film has a transport ratio (TR) of between 43% and 67%.

19. The luminaire according to claim 14 wherein the semi-specular reflective film has a reflectivity of greater than 98% and the semi-specular reflective film has a transport ratio (TR) of between 43% and 67%.

20. The luminaire according to claim 15 wherein the semi-specular reflective film has a reflectivity of greater than 98% and the semi-specular reflective film has a transport ratio (TR) of between 43% and 67%.
